(19) United States
(12) Patent Application Publication
(10) Pub. No.: US 2005/0220973 A1
(43) Pub. Date: Oct. 6, 2005

(54) Reduced fat chip and manufacturing process

(75) Inventor: Kenneth Wilmot, North Yorkshire (GB)

Correspondence Address: LERNER, DAVID, LITTENBERG,;KRUMHOLZ & MENTLIK, 600 SOUTH AVENUE WEST, WESTFIELD, NJ, 07090, US

(73) Assignee: McCain Foods Limited, Florenceville, NB (CA)

(21) Appl. No.: 10/505,940

(22) PCT Filed: Feb. 26, 2003
(86) PCT No.: PCT/GB03/00821

§ 371 Date: Apr. 25, 2005

(30) Foreign Application Priority Data
Feb. 28, 2002 (GB) 0204732.2
Mar. 18, 2002 (GB) 0206416.0

(51) Int. Cl. A23L 1/216

(52) U.S. Cl. 426/637

(57) ABSTRACT

The invention relates to a method of producing a frozen potato chip comprising the steps of peeling a potato, cutting the potato into strips, blanching the strips for a time equal to 60-95% of the time to disintegration, drying the strips by 10-20% by weight reduction in moisture content, frying the strips at 130-160° C. for 20-30 seconds, and freezing the strips. The method has the combined effect of shrinking the surface layer of potato cells, so that a somewhat leathery ‘skin’ is developed. As a consequence the surface layer is less likely to absorb fat during the frying stage. Furthermore, because blanching is carried out to the optimum, the frying stage can be substantially shortened, and thus the opportunity for fat absorption is also reduced whilst allowing a caterer to better satisfy demand for freshly fried chips rather than frying in advance in anticipation of demand.

This invention relates to potato chips, and particularly to part cooked frozen potato chips which are intended to be subjected to final cooking immediately before consumption.

Low and reduced fat chips (sometimes known as oven chips) are popular with consumers. Such chips are part cooked and then frozen for retail sale. Final cooking is typically in an oven so as to avoid the extra fat which would be absorbed during frying.

However oven cooking of frozen chips is not suitable for caterers, because the unit quantity is low, and the speed of cooking is slow. In these circumstances a fryer is the ideal method of final cooking since it can provide a large quantity of chips quickly. Furthermore some consumers prefer a fried chip rather than an oven chip.

What is required is a means of providing caterers with a chip which is low in fat when sold, whilst at the same time meeting the caterers requirements of speed and quantity.

The conventional method of producing frozen potato chips for caterers, typically of 11×11 mm or 14×14 mm cut size, comprises the basic steps of:
peeling, and cutting the potato strips;
blanching the strips at 70-80° C. for 5-20 minutes;
drying the strips to remove 4-8% by weight of moisture;
frying the strips for 30-60 seconds at 180-190° C.; and
freezing the strips.

The drying stage is optional, and not always used. Variations in the process parameters are due to seasonal changes in the natural quality of potatoes, and the size of the raw strips. New potatoes have different frying characteristics from old potatoes; furthermore several chip thicknesses typically in the range 6×6 mm to 14×14 mm are required to suit the requirements of consumers.

In this specification, the word ‘strips’ means any length of potato that is chip shaped having a square or rectangular cross-section. The strip may either be straight or curly.

In practice the potato is usually blanched, dried and fried to the optimum cooking conditions. An experienced processor can determine the required adjustment of cooking conditions by trial and error, and by using knowledge gained from experience. Typically about one third of the total-cooking is by blanching, and about one third by frying before freezing. The final third is completed by the caterer to develop a browned appearance and a crisp outer skin with a dry mealy centre.

In general the invention is characterized by determining a conventional blanching and frying time in order to produce a part cooked chip of the desired quality and suitable for freezing; this step also requires determination of suitable conventional blanching and frying temperatures. The characterizing feature of the invention requires a substantial increase in the blanching time, a substantial reduction in the frying time, and an intermediate drying stage in which 10-20% by weight of moisture is removed for a typical 11×11 mm or 14×14 mm cut size.

According to one aspect the present invention comprises the steps of increasing the blanching time to the point just short of disintegration of the strips, increasing the moisture removed from the blanched strips by at least 100%, and reducing the frying time by 30% or more. Such a method permits the frying temperature to be reduced by 20-60° C., with consequent saving of energy and reduction in further loss of moisture.

The disintegration point can be determined empirically, but may vary by type and batch of potato. The blanched potato should retain sufficient integrity for processing during the drying step, but otherwise it is advantageous to approach the point of disintegration as closely as possible. No technical means are available to determine the point of disintegration by reference to scientific values, but the skilled man will know what is required.

In practice some adjustment of parameters will be required to suit different chip thicknesses. For example a 6×6 mm chip may require a higher degree of moisture removal than a chip of greater thickness but the same quality.

This modification of the known process has the combined effect of shrinking the surface layer of potato cells, so that a somewhat leathery ‘skin’ is developed as the potato surface becomes completely dry. This dry surface layer is generally to be avoided in the conventional m leathery ‘skin’ is developed as the avoided in the conventional method because it tends to result in blistering and mottling of the surface after frying. The dry surface of the present invention has the consequence that the surface layer is less likely to absorb fat during the frying stage. Furthermore, because blanching is carried out to the maximum extent, the frying stage can be substantially shortened, and thus the opportunity for fat absorption is also reduced. Furthermore the frying temperature can be reduced.

It has been found that frozen chips produced according to the invention have a substantially reduced time for final frying, typically a reduction from 240-360 seconds to 90-135 seconds when cooked according to good frying practices. The shorter time reduces fat take-up still further, whilst also permitting the caterer to reduce the time from order to delivery. As a result, the caterer is better able to satisfy demand with freshly fried chips rather than frying in advance in anticipation of demand.

In order to prevent discolouration, and to improve browning of the chips during the final frying process it is known to dip the blanched strips in a 1% by weight solution of sodium acid pyrophosphate, which may be supplemented by a 0.5% by weight solution of dextrose. In a preferred embodiment the strips are dipped in a solution comprising 1.5-2% by weight dextrose in order to enhance colour development during the frying stages. The percentage solution of dextrose may be varied to suit the final colour desired by the consumer. Other methods known to the skilled man may be used to promote browning, such as use of Maillard's reactants or colourants.

The invention also comprises a method of producing a frozen potato chip, and comprising the steps of:
peeling and cutting a potato into strips;
blanching the strips for a time equal to 60-95% of the time to disintegration;
drying the strips by 10-20% by weight reduction in moisture content;
frying the strips at 130°-160° C. for 20-30 seconds; and freezing the strips.

Preferably the strips are of 11×11 mm or 14×14 mm cut size.

Preferably the strips are blanched for a time, equal to 80-90% of the time to disintegration, and preferably the strips are dried to a moisture reduction of 15%. In a preferred embodiment the strips are fried for about 30 seconds at 150° C.

In another aspect the invention comprises a method of producing a cooked potato chip comprising the foregoing method of producing a frozen potato chip, and the additional step of frying the strips for 90-135 seconds.

The invention also provides a method of producing a frozen potato chip, and comprising the steps of:
peeling and cutting a potato into strips;
blanching said strips for at least 50% longer than conventional blanching, at a temperature at least 10% greater than conventional blanching;
drying the strips by removal of at least twice the moisture of a conventional drying step;
frying the strips for less than 70% of a conventional frying time at a temperature at least 30° C. lower than a conventional frying temperature; and
freezing the strips.

Other features of the invention will be apparent from the following description of preferred embodiments.

Pre-packed frozen chips are generally part cooked prior to freezing. This reduces final preparation time, and controls more closely a substantial portion of the overall cooking time.

A conventional process for preparation of frozen chips is as follows. Potatoes are graded, washed, and peeled by a process such as steam peeling. The whole potatoes are then pre-heated and cut into strips by any suitable known method, such as a water gun or rotary cutter. Strips are typically square in section and of a desired thickness, such as 11 mm or 14 mm.

Slivers (side off-cuts) and nubbins (end off-cuts) are removed so that only substantially square section raw potato strips remain.

The strips are blanched in hot water to inactivate particular enzymes, to leach out reducing sugars, and to partially cook the potato. Generally, the blanching time may be about one third of the time required to fully cook the potato. The blanching time varies considerably through the season according to the age and quality of all available potatoes and may vary from 5-20 minutes at 70-80° C. A generally conservative approach is typically adopted, so that there is no risks of overcooking during the blanching step.

After blanching the strips are typically dipped in a 1% solution of sodium acid pyrophosphate to prevent oxidation, and sometimes in a 0.5% solution of dextrose to promote a golden fried colour. The strips may also be partially dried to a moisture loss of 4-8%.

Finally the strips are par fried so as to reduce frying time for the caterer and to help develop the desired texture. During this stage further moisture is removed, and the chips begin to develop a somewhat crispy skin. Typical frying times, again dependant on seasonal variation, is in the range 30-60 seconds at 180-190° C. The chips are then frozen and packed for sale. Final cooking by the caterer would typically require frying for 150-240 seconds.

According to the present invention, the conventional process is varied in the following manner.

The blanching step is much longer, typically for 15-30 minutes at 80-90° C.

The dipping stage requires immersion in a 1.5-2.0% by weight solution of dextrose.

The drying stage results in a moisture loss of 10-25% by weight.

The par frying stage is in the range 20-30 seconds at 130-160° C.

The final cooking stage requires frying for 90-135 seconds.

By increasing the blanching time, the potato is cooked to the greater extent, and thus less frying time is required. However it has been observed that by increasing the moisture loss at the drying stage, the cells at the surface of the potato strips tend to shrink, and present a somewhat leathery appearance. Such shrinkage would not be expected if the strips were blanched and/or dried only to the extent required in the prior process. In fact, a dry leathery skin is generally to be avoided.

Dipping in a stronger dextrose solution tends to enhance colour development so that the chips can achieve a browned appearance notwithstanding a shorter frying time.

Par frying time is reduced, because a greater proportion of cooking occurs during the blanching stage. Fat absorption is reduced because of the shorter frying time, but also because the cells at the surface of the potato have shrunk, and are thus more resistant to fat.

A feature of the inventive process is that final frying time is also substantially reduced, and thus the opportunity for further fat absorption is also reduced.

The process of the invention is generally applicable to all production methods for part cooked frozen chips, in order to reduce the fat content thereof.

1. A method of processing a potato, and comprising the steps of:
peeling and cutting a potato into strips;
blanching the strips for a time equal to 60-95% of the time to disintegration;
drying the strips by moisture removal to obtain 10-20% weight reduction;
frying the strips at 130°-160° C. for 20-30 seconds; and
freezing the strips.

2. A method according to claim 1, wherein the strips are blanched for a time equal to 80-90% of the time to disintegration.

3. A method according to claim 1 or claim 2, wherein the strips are dried to a moisture reduction of 15% by weight.

4. A method according to claim 1, 2 or 3, wherein the strips are fried for 30 seconds at 150° C.

5. A method of processing a potato, and comprising the steps of:
peeling and cutting a potato into strips;
blanching the strips for at least 50% longer than conventional blanching, at a temperature at least 10% greater than conventional blanching;
drying the strips by removal of at least twice the moisture of a conventional drying step;
frying the strips for less than 70% of a conventional frying time at a temperature at least 30° C. lower than a conventional frying temperature; and
freezing the strips.

6. A method according to a preceding claim and further comprising the step of immersing the strips in a solution of dextrose of 1.5-2.0% by weight prior to drying the strips.

7. A method according to any preceding claim and further comprising a final step of frying the strips for 90-135 seconds.

8. A frozen potato strip provided according to any one of the preceding methods.
